(19) United States
(12) Patent Application Publication
(10) Pub. No.: US 2014/0184639 A1
(43) Pub. Date: Jul. 3, 2014

(54) ELECTRONIC DEVICE WITH MUTIPLE DISPLAY SCREENS AND METHOD FOR CONTROLLING DISPLAY SCREENS

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: XIN GUO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/109,906

(22) Filed: Dec. 17, 2013

(30) Foreign Application Priority Data
Dec. 28, 2012 (CN) 2012105823006

(51) Int. Cl. G09G 5/12

(52) U.S. Cl. CPC G09G 5/12
USPC 345/629

(57) ABSTRACT

An electronic device provided comprises a case, a main display screen, at least one auxiliary display screen, an input unit and a processor. The auxiliary display screen is arranged beside the main display screen. The input unit selectively generates a display control signal in response to a manual operation. The processor controls the main display screen and the auxiliary display screen to form a combined display to display content in response to the full display signal or control only the main display screen to display content in response to the main display signal. A method for controlling display screens of the electronic device is also provided.

### BACKGROUND

1. Technical Field

The present disclosure relates to electronic devices, and particular to an electronic device with multiple display screens and a method for controlling the display screens.

2. Description of Related Art

With the development of the science and the technology, electronic devices such as mobile phones are used for watching video or browsing web pages. However, the size of the screen of a mobile phone is usually restricted by the size of the mobile phone.

Therefore, it is necessary to expand the size of display screen when the size of the mobile phone remains unchanged.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a mobile phone, in accordance to an exemplary embodiment of the present disclosure.

FIG. 2 is a block diagram of the mobile phone in FIG. 1.

FIG. 3 is a flowchart of method for controlling the display screens of the mobile phone, in accordance to an exemplary embodiment of the present disclosure.

### DETAILED DESCRIPTION

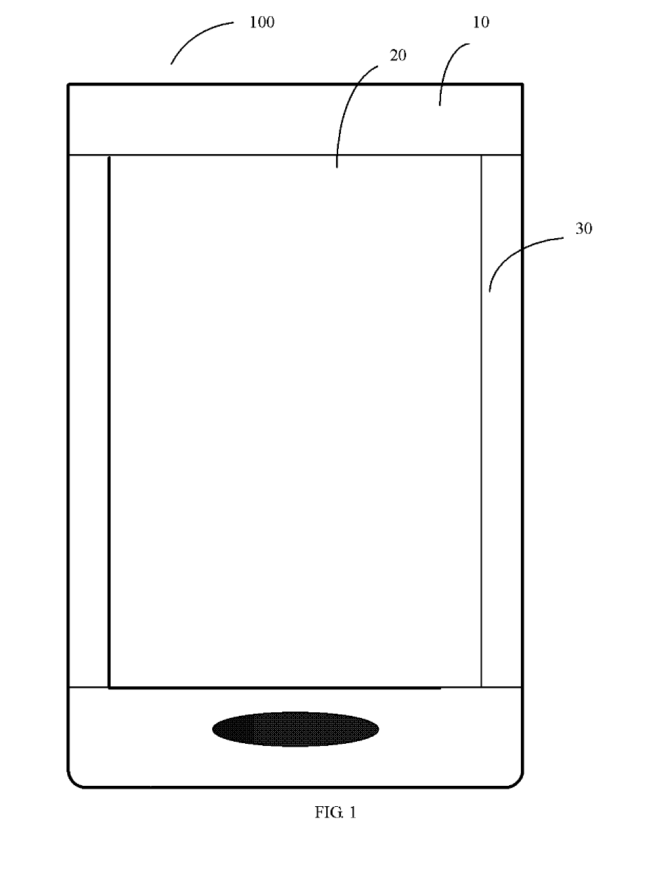

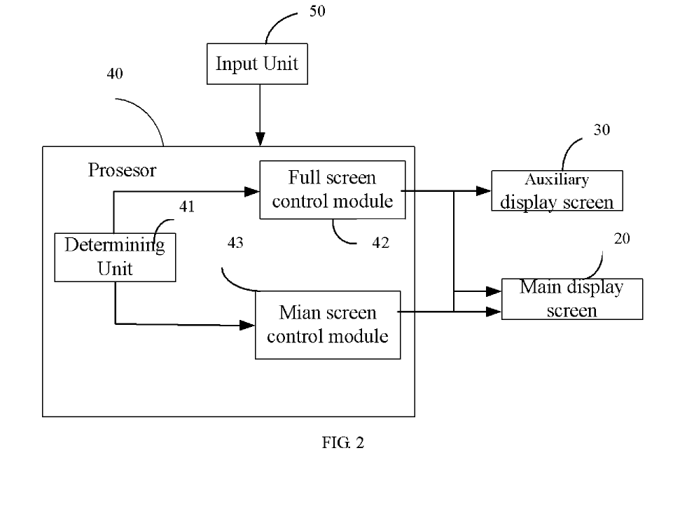

FIGS. 1 and 2 show an electronic device 100 in accordance to an exemplary embodiment of the present disclosure. The electronic device 100 includes a case 10, a main display screen 20 and at least one auxiliary display screen 30, a processor 40 and an input unit 50. The electronic device 100 also includes other components (not shown) to deal with common functions of the electronic device 100. In this embodiment, the electronic device 100 is a mobile phone.

The main display screen 20 and the auxiliary display screen 30 are both mounted on a same side of the case 10. The auxiliary display screen 30 is arranged around the main display screen 20. In the embodiment, there are two auxiliary display screens 30 and the two auxiliary display screens 30 are arranged at two opposite sides of the main display screen 20 and extend to the edges of the case 10. Equipped with the main display screen 20 and the auxiliary display screens 30, the electronic device 100 includes a full screen mode and a main screen mode. In the full screen mode, the main display screen 20 and the auxiliary display screens 30 are combined to display contents. In the main screen mode, only the main display screen 20 displays contents.

The processor 40 is connected to the input unit 50. The processor 40 includes a determining module 41, a full screen control module 42 and a main screen control module 43.

The input unit 50 is configured to generate display control signals in response to manual operations. In the embodiment, the control signals generated by the input unit 50 include a full screen control signal and a main screen control signal.

The determining module 41 is configured to determine the control signal generated by the input unit 50 is the full screen control signal or the main screen control signal.

The determining module 41 is further configured to generate a first signal and send the first signal to the full screen control module 42 when the control signal generated by the input unit 50 is a full screen control signal. In addition, generate a second signal and send the second signal to the main screen control module 42 when the control signal generated by the input unit 50 is a main screen control signal, so that the mobile phone 100 enters the full screen mode or the main screen mode. In the main screen mode, the auxiliary display screens 20 are idle or powered off

The full screen control module 42 is configured to control the auxiliary display screens 30 and the main display screen 20 to form the combined display to display content such as an electronic file in response to the first signal in the full screen mode.

The main screen control module 42 is configured to control only the main display screen 20 to display content in response to the second signal in the main screen mode. The content is a text file, picture file, video file or music file, for example.

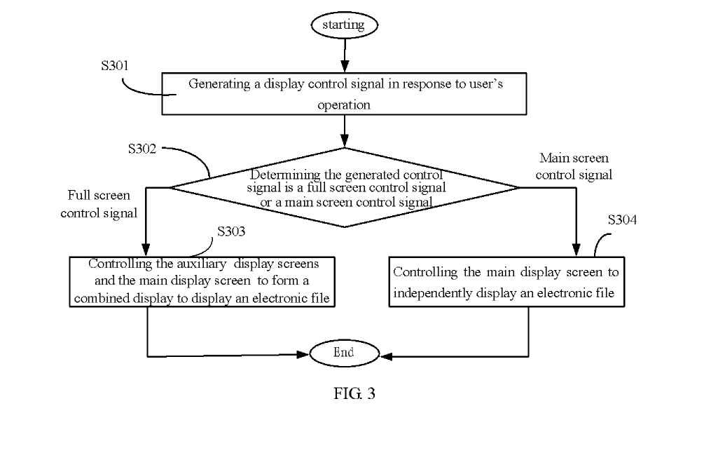

FIG. 3 shows a flowchart of a method for controlling the display screens of the electronic device 100. The method includes following steps:

In step S301, the input unit 50 generates a display control signal in response to manual operation.

In step S302, the determining module 41 determines the control signal generated by the input unit 50 is a full screen control signal or a main screen control signal. When the determining module 41 determines the generated control signal is a full screen control signal, the process goes to step S303; when the determining module 41 determines the generated control signal is a main screen control signal, the process goes to step S304.

In step S303, the full screen control module 42 controls the auxiliary display screens 30 and the main display screen 20 to cooperate to form a combined display to display an electronic file.

In step S304, the main screen control module 43 controls only the main display screen 20 to display an electronic file. In the illustrated embodiment, the main screen control module 43 controls to switch off the at least one auxiliary display screen 30.

The electronic device 100 and the method for controlling the display screens of the electronic device provided by the present disclosure allows user to adopt an appropriate display mode according to the electronic file. For example, when the electronic file is a video file, user can adopt the full screen mode to display the electronic file to have a better visual effect. When the electronic file is a text message, user can adopt a main screen mode to display the text message to decrease the consumption of the power.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure.

Therefore, the scope of the appended claims should not be limited to the description of the preferred embodiments described above.

What is claimed is:

1. An electronic device, comprising:
a case;
a main display screen;
at least one auxiliary display screen arranged beside the main display screen;
an input unit configured to selectively generate a full display control signal or a main display control signal in response to a manual operation; and
a processor configured to control the main display screen and the auxiliary display screen to form a combined display to display content in response to the full display signal and control only the main display screen to display content in response to the main display signal.

2. The electronic device described as in claim 1, wherein the auxiliary display screen extends to an edge of the case.

3. The electronic device described as in claim 2, wherein the processor comprises a determining module, a full screen control module and a main screen control module, the determining module is configured to determine the generated control signal is a full screen control signal or a main screen control signal; the full screen control module is configured to control the at least one auxiliary display screen and the main display screen to form the combined display to display the content when the determining module determines that the generated control signal is a full screen control signal, the main screen control module is configured to control only the main display screens to display the content when the determining module determines that the generated control signal is a main screen control signal.

4. The electronic device described as in claim 1, wherein the content is selected from the group consisting of a text file, a picture file, a video file and a music file.

5. The electronic device described as in claim 3, wherein the at least one auxiliary display screen includes two auxiliary display screens, the two auxiliary display screens are mounted on the opposite sides of the main display screen.

6. A method for controlling display screens of an electronic device, wherein the electronic device comprises a main display screen, at least one auxiliary display screen arranged beside the main display screen, a input unit and a processor, the method comprising:
generating a full display control signal or a main display control signal in response to a manual operation;
controlling the main display screen and the auxiliary display screen to cooperate to form a combined display to display an electronic file when a full display control signal is generated; and
controlling only the main display screen to display an electronic file when a main display control signal is generated.

7. The method described as in claim 6, further comprising:
switching off the at least one auxiliary display screen when the main display control signal is generated.
